(19) United States
(12) Patent Application Publication
(10) Pub. No.: US 2025/0378983 A1
(43) Pub. Date: Dec. 11, 2025

(54) TRANSFORMER CORE ASSEMBLY HEAT EXCHANGER WITH NONLINEAR OUTER SURFACE

(71) Applicant: Caterpillar Inc., Peoria, IL (US)

(72) Inventors: Rien W. O'STEEN, Saint Johns, FL (US); Eric M. ANDRIS, Dunlap, IL (US)

(73) Assignee: Caterpillar Inc., Peoria, IL (US)

(21) Appl. No.: 19/217,459

(22) Filed: May 23, 2025

Related U.S. Application Data
(60) Provisional application No. 63/657,158, filed on Jun. 7, 2024.

(51) Int. Cl. H01F 27/22; H01F 27/24; H01F 27/28; H01F 41/04

(52) U.S. Cl. CPC H01F 27/22; H01F 27/24; H01F 27/28; H01F 41/04

(57) ABSTRACT

An electrical transformer core assembly may include a magnetic core, a set of coils, including a primary coil surrounding a first portion of the magnetic core, and a secondary coil surrounding the primary coil, and a heat exchanger located between the magnetic core and the primary coil. The heat exchanger may also include a heat exchanger body including an outer surface and an inner surface, wherein the outer surface is substantially non-linear as viewed in a cross-sectional plane normal to a longitudinal axis of the body, and the inner surface substantially conforms to an outer surface of the magnetic core.

### CROSS-REFERENCE TO RELATED APPLICATION

This application claims the benefit of priority to U.S. Provisional Patent Application No. 63/657,158, filed on Jun. 7, 2024, the entirety of which is incorporated herein by reference assemblies.

### TECHNICAL FIELD

The present disclosure relates to heat exchangers, and, more particularly, heat exchangers in electrical transformer core assemblies.

### BACKGROUND

Electrical transformers (or simply “transformers”) transfer electrical energy from one electrical circuit to another through electromagnetic induction. Transformers have applications in, for example, energy storage systems on electric machines. Specifically, transformers may increase or decrease voltage and/or current between an energy supply (e.g., a battery) and an electric motor in an electric driven machine. As energy demands in electrical machines increase, more electrical energy may be lost as thermal energy through, e.g., core losses or copper losses in transformers. That is, when more electrical energy is transferred through a transformer, the thermal energy losses may increase and, therefore, require appropriate removal for optimal performance or to reduce damage to, and/or failure of, the transformer.

Some transformers include magnetic core assemblies having a rectangular cross-sectional area and primary coils (e.g., copper windings) wound circumferentially around the rectangular core. Winding the primary coils around the rectangular core may increase the stress on the windings at the corners, decrease overall winding tension, and may introduce entrapped intralayer air, thereby reducing thermal conduction and increasing internal temperatures. The intralayer air may create hotspots (e.g., areas of localized increased temperature) that in turn may create thermal regulation difficulties and overheating issues in the transformer.

A liquid-cooled inductive component is described in US 2012/0262264 A1 (“the '264 publication”) to Thorsten. The liquid-cooled inductive component described in the '264 publication includes pressure pieces which are arranged on two opposite sides of a magnetic core and are in mechanical contact with the magnetic core either directly or via a thermally conductive material. While the vehicle described in the '264 publication may be useful for heat dissipation in inductive components, it may be unable to provide adequate heat dissipation in transformers where differences in the geometry of the magnetic core and the primary coil exist.

Embodiments of the present disclosure may solve one or more of the problems set forth above and/or other problems in the art. The scope of the current disclosure, however, is defined by the attached claims, and not by the ability to solve any specific problem.

### SUMMARY

In one aspect of the present disclosure, an electrical transformer may include a magnetic core, a set of coils, including a primary coil surrounding a first portion of the magnetic core, and a secondary coil surrounding the primary coil, and a heat exchanger located between the magnetic core and the primary coil. The heat exchanger includes a heat exchanger body including an outer surface and an inner surface, wherein the outer surface is substantially non-linear as viewed in a cross-sectional plane normal to a longitudinal axis of the body, and the inner surface substantially conforms to an outer surface of the magnetic core.

In another aspect of the present disclosure, an electrical transformer may include a magnetic core, and a heat exchanger located on the magnetic core. The heat exchanger includes a heat exchanger body and at least one cooling tube, and the heat exchanger body includes an outer surface and an inner surface, wherein the outer surface is substantially curved as viewed in a cross-sectional plane, and the inner surface substantially conforms to an outer surface of the magnetic core.

In still another aspect of the present disclosure, a method of forming an electrical transformer may include securing a heat exchanger about a magnetic core. The heat exchanger includes a heat exchanger body including an outer surface opposite an inner surface, wherein the outer surface is substantially continuously curved as viewed in a cross-sectional plane of the heat exchanger body, and the inner surface substantially conforms to an outer surface of the magnetic core. The method further includes forming a primary coil by wrapping first foil about the heat exchanger, securing spacers about the primary coil, and forming a secondary coil by wrapping a second foil about the spacers.

### BRIEF DESCRIPTION OF THE DRAWINGS

The accompanying drawings, which are incorporated in, and constitute a part of, this specification, illustrate various exemplary embodiments and, together with the description, serve to explain the principles of the disclosed embodiments.

FIG. 1 shows a cross-sectional schematic view of an electrical transformer core assembly, according to aspects of this disclosure.

FIG. 2 shows a partial cross-sectional end view of the electrical transformer core assembly of FIG. 1 along line 2-2.

FIG. 3 shows a perspective view of a first end of the heat exchanger removed from the core assembly of FIG. 1.

FIG. 4 shows a perspective view of a second end of the heat exchanger of FIG. 3.

FIG. 5 shows a perspective view of an interior of the heat exchanger of FIG. 3.

FIG. 6 shows a flowchart of a method of forming the transformer core assembly of FIG. 1.

FIG. 7 shows a cross-sectional schematic view of an electrical transformer core assembly.

FIG. 8 shows a perspective view of a heat exchanger removed from the core assembly of FIG. 7.

FIG. 9 shows a top-view of the heat exchanger of FIG. 8.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

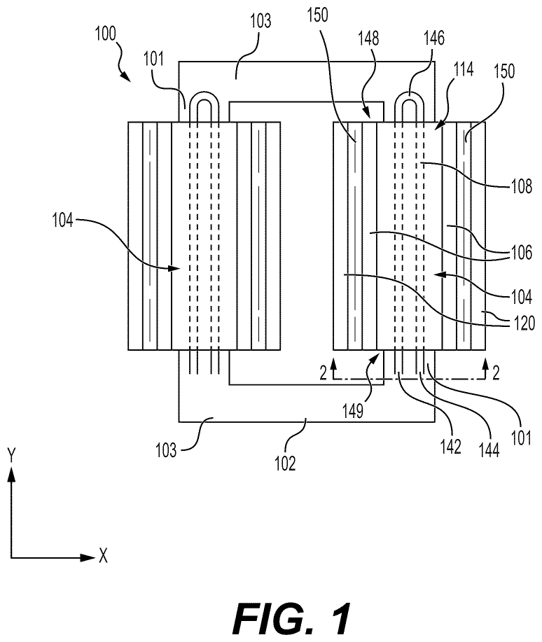

FIG. 1 shows a partial cross-sectional schematic view of an exemplary transformer core assembly 100. Transformer core assembly 100 may be used in any electrical transformer for stepping voltage up or down between circuits. The transformer core assembly 100 is depicted as a single phase, core type transformer core assembly 100, however it is understood that the present disclosure is applicable to other types of transformer core assemblies, such as three phase and/or shell type transformer core assemblies. Transformer core assembly 100 may include a magnetic core 102 having two legs 101 and two yokes 103. This disclosure will detail the components and functions associated with one leg 101 of transformer core assembly 100, and such description will be equally applicable to the components and functions of the other leg 101 of the transformer core assembly 100.

Transformer core assembly 100 may include the magnetic core 102, a heat exchanger 104 surrounding portions of the magnetic core 102, a primary coil or winding 106 surrounding portions of the heat exchanger 104, cooling tubes 150 surrounding portions of the primary coil 106, and a secondary coil or winding 120 surrounding portions of the cooling tubes 150. Transformer core assembly 100 may also include additional components, e.g., protection relays, busbars, an enclosure, etc., as is known in the art.

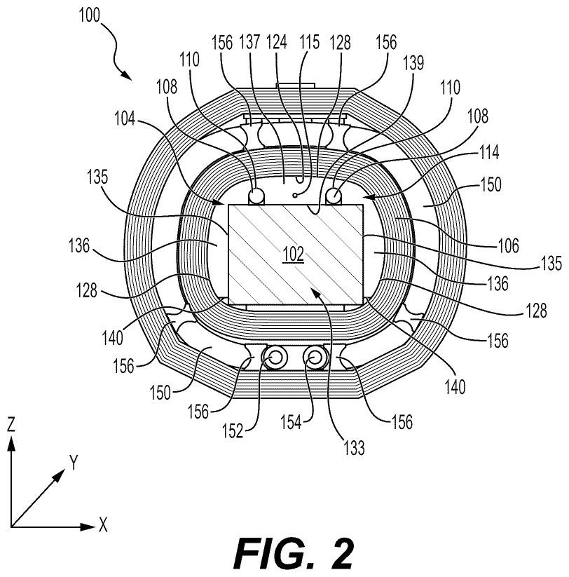

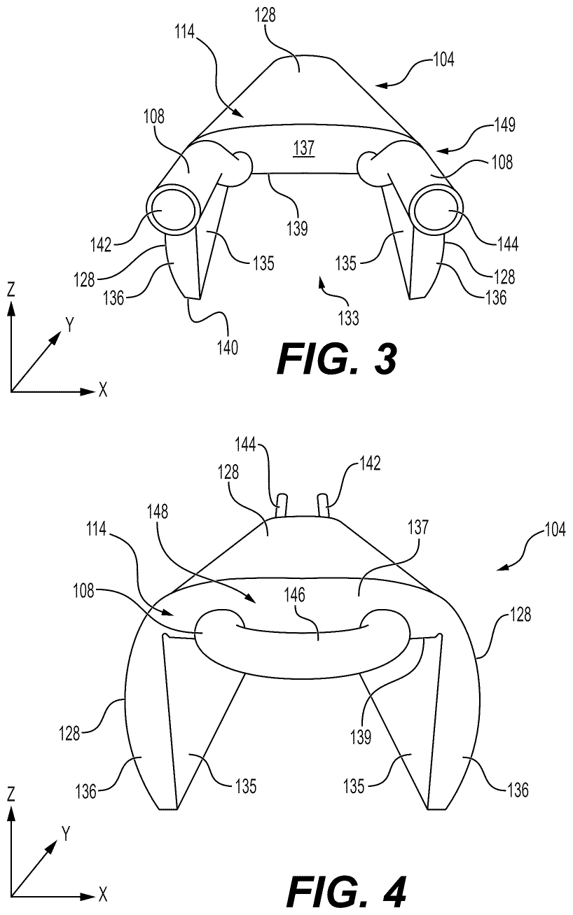

As shown best in the cross-section view of FIG. 2, magnetic core 102 may include a substantially rectangular cross-sectional shape, as viewed in a plane normal to a longitudinal axis of a core leg 101. Magnetic core 102 may include opposing outer surfaces. Magnetic core 102 may be formed in any appropriate configuration and with any appropriate magnetic material, such as a ferromagnetic material including iron or steel. For example, magnetic core 102 may be formed by a plurality of stacked steel sheets mechanically connected together. While FIG. 1 depicts magnetic core 102 as a rectangular loop having two legs 101, the loop may have alternative shapes, such as triangular, etc.

Referring again to FIG. 2, heat exchanger 104 includes an elongate body 114 having a substantially C-shaped or U-shaped cross-section and a longitudinal axis 115. Thus, heat exchanger 104 includes an open end 133, a pair of sides or legs 136 and a base 137 connecting the legs and located opposite the open end 133. The elongate body 114 includes an inner surface substantially conforming to the shape of the magnetic core 102. In particular, elongate body 114 of heat exchanger 104 includes a pair of substantially planar and parallel inner surfaces 135 on each of the side or leg 136. Body 114 also includes a substantially planar inner surface 139 on the base 137, wherein the inner surface 139 of the base 137 is substantially perpendicular to the inner wall surfaces 135 of each side or leg 136. Substantially planar surface 139 may include a pair of parallel longitudinal grooves 110 for receiving one or more cooling tubes 108, as will be explained in more detail below. Legs or sides 136 of longitudinal body 114 may extend (in the Z-direction in FIG. 2) to cover substantially all, e.g., 85% to 95%, of the corresponding sides of magnetic core 102. Also, as shown in FIG. 2, base 137 (and cooling tubes 108) of heat exchanger 104 cover substantially all of the corresponding side of magnetic core 102 (in the X-direction in FIG. 2). Heat exchanger 104 may be formed of any appropriate material, such as a metal or any other suitable thermally-conductive material or materials.

Elongate body 114 of heat exchanger 104 may also include an outer surface 128 that is substantially non-linear, as viewed in a cross-sectional or transverse plane normal to the longitudinal axis 115, as shown in FIG. 2. For example, outer surface 128 of body 114 may be continuously curved, e.g., without discontinuities, and may form a substantially rectangular continuous curvature as shown, where the outer curved surface 128 of base 137 may be longer than the outer curved surface 128 of sides or legs 136. Alternatively, curved surface 128 could be the same length for each of the base 137 and sides or legs 136, and thus approximate a cylindrically-shaped outer surface 128. While outer surface 128 is shown as having a continuously curved outer surface, it is understood that non-curved portions of surface 128 could be included, such as at one or more transitions between the sides or legs 136 and the base 137 or include substantially planar ends 140 of sides or legs 136 adjacent the open end 133. As will be discussed in more detail below, the substantially planar and parallel inner surfaces 135 on each of the sides or legs 136, the substantially planar inner surface 139 on the base 137, and the curved outer surface 128 of elongate body 114 of heat exchanger 104 provides for a matching, conformal, or corresponding surface for both the rectangularly-shaped magnetic core 102 and for an inner surface 124 of primary coil or winding 106.

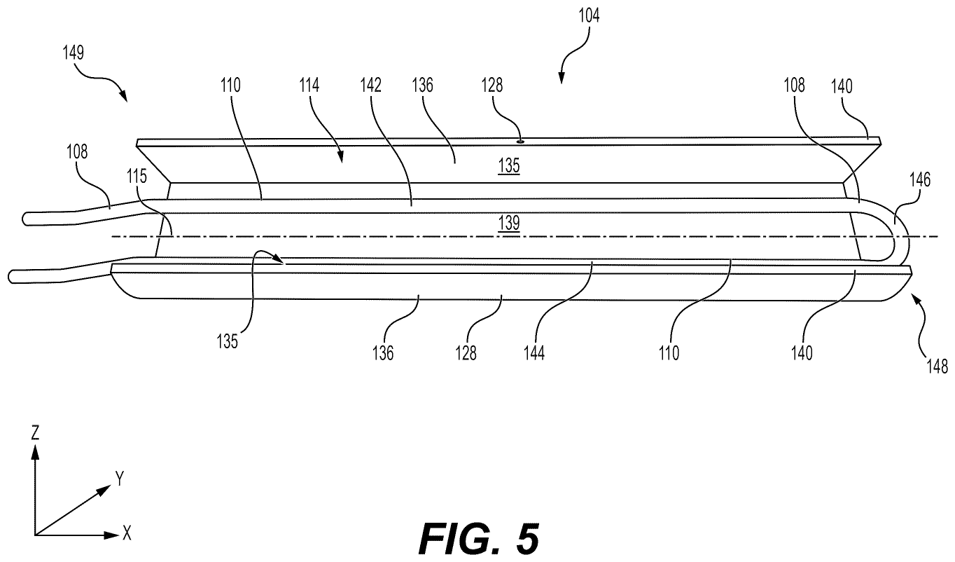

As noted above, heat exchanger 104 may include at least one cooling tube 108 (shown partially in phantom in FIG. 1) located within a pair of parallel grooves 110 in base inner surface 139. As best shown in FIG. 5, cooling tube 108 may be substantially U-shaped including an inlet side 142 and an outlet side 144 extending parallel to one another and along the entire length of the heat exchanger body 114 (e.g., the X-direction in FIG. 5). As best shown in FIG. 2, cooling tube 108 may be substantially centrally aligned in base 137 (e.g., in the X-direction in FIG. 2) and may be located in grooves 110 so that the cooling tube 108 is substantially flush with inner planar surface 139 of base 137. Further, cooling tube 108 may include a U-turn portion 146 at one end of the cooling tube 108 and the U-turn portion 146 is located outside the elongate body 114 of heat exchanger 104 at one longitudinal end 148 of the elongate body 114. Inlet and outlet ends of cooling tube 108 may extend out a longitudinal end 149 of elongate body 114 located opposite the longitudinal end 148 having the U-turn portion 146. While the cooling tube 108 is only shown as included in the base 137, it is understood that the cooling tube may be alternatively located in one or both of legs 136, or in the base 137 and the legs 136. Further, while the cooling tube 108 is situated flush with the inner surface 139 of base 137, the cooling tube 108 could additionally or alternatively be located internal to the base 137 and/or one or more legs 136.

Cooling tube 108 may be formed of any appropriate material, e.g., metal may include a variety of materials, including stainless steel or aluminum. In some implementations, cooling tube 108 may be the same material as body 114 to avoid, e.g., galvanic conversion. While cooling tube is disclosed as having a substantially U-shape, it is understood that cooling tube 108 could have different shapes, such as multiple U-shaped portions, longitudinally extending zig-zag portions, and/or include an inlet manifold on one longitudinal end and an outlet manifold at an opposite longitudinal end of elongate body 114 of heat exchanger 104. Also, cooling tube 108 may be formed merely by one or more bores extending through body 114.

Primary coil 106 may circumferentially surround heat exchanger 104, as illustrated in FIG. 2. Primary coil 106 may include, for example, a foil wrapped in layers (illustrated as concentric circles in FIG. 2) around heat exchanger 104, and in particular around curved outer surface 128 of elongate body 114 of heat exchanger 104. Thus, an inner surface 124 of primary coil substantially conforms to the outer surface 128 of elongate body 114. Primary coil 106 may be any suitable conductive material, such as a tightly-wound copper foil.

Transformer core assembly 100 may also include additional cooling tube(s) 150 surrounding primary coil 106. Such additional cooling tube(s) 150 may include any appropriate material. Referring to FIG. 2, additional cooling tube(s) 150 may include an inlet 152 and an outlet 154 on an opposite side (e.g., opposite in either or both of the Y-direction or the Z-direction) of magnetic core 102 than inlet 142 and outlet 144 of cooling tube 108. In some arrangements, inlet 152 and outlet 154 may be adjacent a side of magnetic core 102 that includes open end 133 of elongate body 114 of heat exchanger. Additional cooling tube(s) 150 may be located circumferentially about primary coil 106, and may coil or wrap back and forth longitudinally about primary coil 106 forming longitudinally parallel portions. Additional cooling tube(s) 150 may include any material, such as, e.g., rubber, metal, etc. Longitudinally extending spacer members 156 may be located to extend radially from an outer surface of primary coil 106 so as to provide proper spacing for the additional cooling tube(s) 150. Spacers 156 may be any suitable spacer material, e.g., rubber, and may be of any appropriate length (Y-direction), height, and number.

The secondary coil or winding 120 may surround the additional cooling tube and spacers 156. Secondary coil 120 may be substantially similar to primary coil 106 in all respects, or may be different in some aspects. For example, secondary coil 120 may include a different number of turns than primary coil 106.

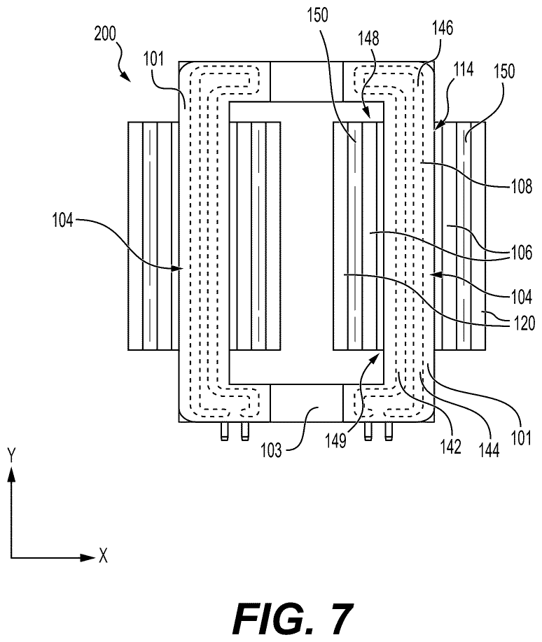

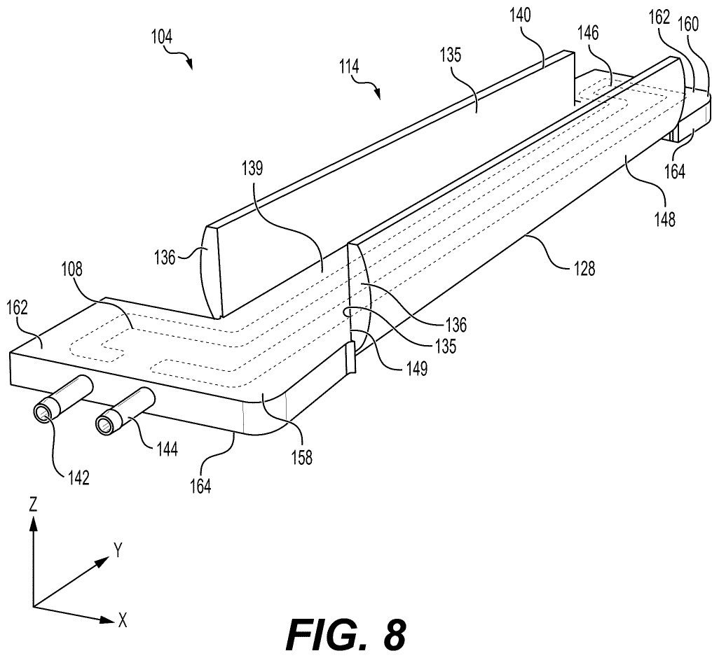

FIG. 7 shows a partial cross-sectional schematic view of an electrical transformer core assembly 200 similar to the electrical transformer core assembly 100 in other embodiments, except that the heat exchanger 104 further includes an extension 158 extending from the heat exchanger body 114. Each heat exchanger 104 may include one, two, or more extensions 158. In some embodiments, heat exchanger 104 may include a second extension 160 (hereinafter “first extension 158” and “second extension 160”). The extensions 158 and 160 may be substantially identical, except for the placement of the inlet 142 and the outlet 144 on the extensions 158 and 160 may vary. For example, inlet 142 and outlet 144 may both be positioned along first extension 158 while neither of inlet 142 and outlet 144 is positioned along second extension 160. In some embodiments, the extensions 158 and 160 may be substantially planar, as best shown in FIG. 8. In other embodiments, the extensions 158 and 160 may extend from the body 114 in any appropriate orientation, e.g., longitudinally (e.g., in the Y-direction), laterally (e.g., in the X-direction) or diagonally (e.g., in the X-Y directions). In one embodiment, shown in FIG. 7, the body 114 may extend over the leg 101 of core 102 in the Y-direction, while the extension 158 or 160 may extend from the body 114 along the yoke 103 in the X-direction. However, in other embodiments, the extension 158 or 160 may extend along part of the leg 101 and part of the yoke 103. In some embodiments, the extensions 158 and/or 160 may cover, e.g., the remaining 5-15% of the magnetic core 102 leg 101 not covered by the body 114. The extensions 158 and 160 may include an inner surface 162 opposite an outer surface 164. As shown in FIG. 8, in some embodiments, the outer surface 164 may be above or below the outer surface 128 of the body 114 (e.g., in the Z-direction). In one embodiment, best shown in FIG. 8, the inner surface 162 may be flush with the inner surface 139 of the body 114. The extensions 158 and 160 may be the same material as the heat exchanger 104, e.g., metal or any other suitable thermally-conductive material.

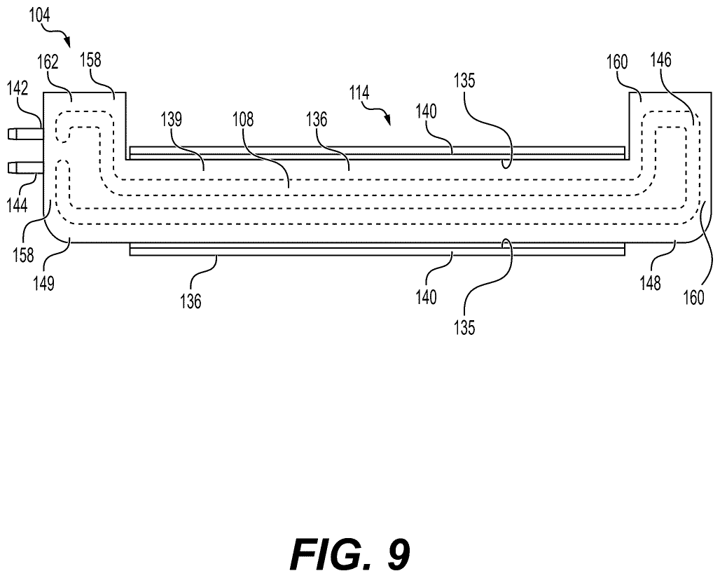

The cooling tube 108 may extend within the extensions 158 and/or 160, as shown in FIGS. 7-9. When the cooling tube 108 extends within extensions 158 or 160, the U-turn portion 146 may be within extensions 158 or 160. In some embodiments, the cooling tube 108 may extend along the body 114 in the Y-direction, while the U-turn portion 146 may extend through the first extension 158 in the X-direction. The cooling tube 108 may include lateral portions in the extension 158 just before inlet 142 and outlet 144. In some embodiments, the inlet 142 and the outlet 144 may each be located on the first extension 158 or on the second extension 160. In other embodiments, the inlet 142 may be on the first extension 158, while the outlet 144 may be on the second extension 160, or any combination thereof.

### INDUSTRIAL APPLICABILITY

Heat exchanger 104 may be used for heat dissipation with any suitable electrical transformer. In particular, heat exchanger 104 may be used to dissipate heat in transformers when placed conformally between the magnetic core and primary coil thereof, which may increase the performance and the lifespan of the transformer by helping to protect the transformer from detrimental high temperatures.

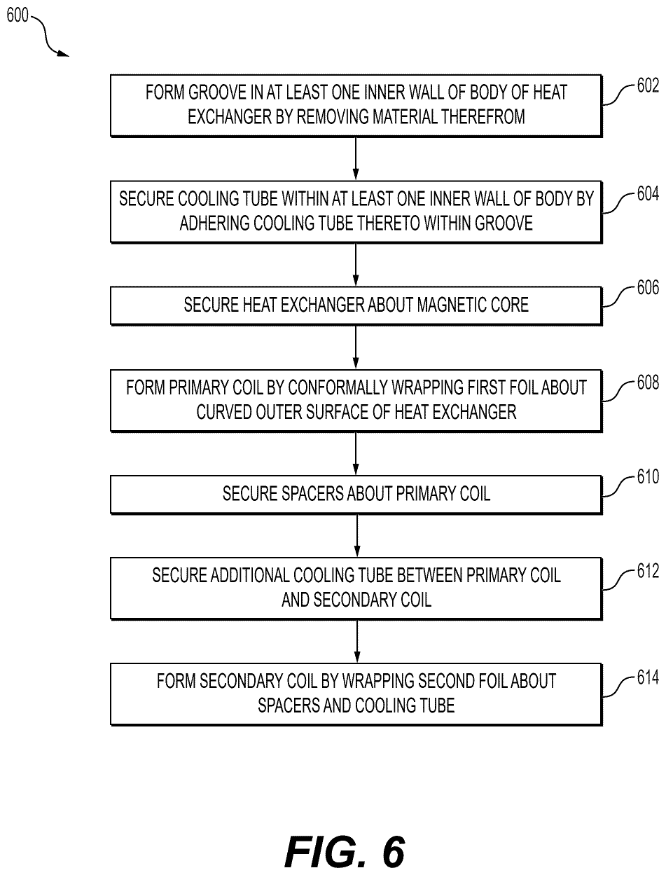

A method of forming transformer 100 is illustrated by representative steps consistent with the present disclosure in the flowchart in FIG. 6. For the method of FIG. 6, the steps in which the method is described are not intended to be construed as a limitation. Any number of steps may be combined in any order to implement the disclosed method and can be performed in parallel to implement the processes. In some embodiments, one or more blocks of the processes may be omitted entirely. Moreover, the processes can be combined in whole or in part with other methods.

In FIG. 6, method 600 may include step 602, including forming groove 110 in at least one respective inner wall, e.g., base 137 inner surface 139, of body 114 by removing material therefrom. Removing material may include, e.g., milling a portion of inner wall of body 114 to the desired size and shape for future placement of cooling tube 108 therein, e.g., cooling tube 108 may be mechanically secured within groove 110.

Method 600 may include step 604, including securing cooling tube 108 within at least one inner wall 139 of body 114 by adhering cooling tube 108 within respective groove 110. Cooling tube 108 may be adhered to inner wall 112 by, e.g., an adhesive or friction stir welding. Friction stir welding is a solid-state joining process used to join two materials together without melting them by using pressure and friction to soften the area at the joint and subsequently allowing them to resolidify.

Method 600 may include step 606, including securing heat exchanger 104 about magnetic core 102. Heat exchanger 104 may be secured around magnetic core 102 in any suitable manner, e.g., with a suitable adhesive, or alternatively, may be merely coupled to magnetic core 102 without any securing.

Method 600 may include step 608, including forming primary coil 106 by wrapping a respective first foil about respective heat exchanger 104. The first foil may be tightly wrapped to avoid forming gaps or air pocket therein. The first foil may be wrapped conformally about curved outer surface 128 of body 114 to eliminate gaps therebetween to improve the heat transfer function of heat exchanger 104.

Method 600 may include step 610, including securing spacers 156 about an outer surface of primary coil 106. Spacers 156 may be, for example, adhesively secured to primary coil 106. Alternatively, spacers 156 may be secured in place by compression by the secondary coil 120.

Method 600 may include step 612, including, before forming secondary coil 120, securing additional cooling tube(s) 150 between respective primary coil 106 and secondary coil 120. Securing additional cooling tube(s) 150 may include securing additional cooling tube(s) 150 circumferentially about primary coil 106 by coiling the additional cooling tube(s) 150 back and forth longitudinally along primary coil 106 and between and around spacers 156.

Method 600 may include step 614, including forming secondary coil 120 by wrapping respective second foils about spacers 156 and additional cooling tube(s) 150. Secondary coil 120 may be formed similarly to primary coil 106 but, for example, with a different number of turns of the second foils than in the first foils. That is, the number of turns in each primary coil 106 and secondary coil 120 may be different, depending on the desired voltage or current change between primary coil 106 and secondary coil 120.

The disclosed system and method may facilitate heat dissipation in transformer core assembly 100, even when transformer core assembly 100 includes components, such as magnetic core 102 and primary coil 106, that have different geometries. In particular, the system and method may facilitate heat dissipation by including heat exchanger 104 between magnetic core 102 that includes a substantially rectangular cross-sectional area and primary coil 106 including a substantially curved inner surface. In such a conforming arrangement, gaps between the outer surfaces of the magnetic core 102, the heat exchanger 104, and the inner surface of the primary coil 106 may be minimized, thus reducing potential localized areas of high temperatures. In that way, heat exchanger 104 helps to remove heat from magnetic core 102 and/or primary coil 106. Heat exchanger 104 may provide heat dissipation in transformer core assembly 100 by conducting heat away from magnetic core 102 and/or primary 106 via circulation of coiling fluid through cooling tube 108. Also, the conforming surfaces between heat exchanger 104 and magnetic core 102 and primary coil 106 may provide additional structural support for core assembly 100 and may enable the primary coil 106 to be wound with high tension normal to the surface of the heat exchanger 104. This may increase both the thermal conduction of the primary coil 106 to the heat exchanger and the heat transfer between the layers of the primary coil 106 due to the reduction or elimination of intralayer entrapped air. Finally, such an arrangement may provide for a primary coil 106 with reduced height, thus assisting in beneficially reducing the size of the transformer core assembly 100.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. An electrical transformer core assembly, comprising:
a magnetic core;
a set of coils, including:
a primary coil surrounding a first portion of the magnetic core, and
a secondary coil surrounding the primary coil; and
a heat exchanger located between the magnetic core and the primary coil, the heat exchanger including a heat exchanger body including an outer surface and an inner surface, wherein the outer surface is substantially non-linear as viewed in a cross-sectional plane normal to a longitudinal axis of the body, and the inner surface substantially conforms to an outer surface of the magnetic core.

2. The electrical transformer core assembly of claim 1, wherein the substantially non-linear outer surface of the heat exchanger body is curved, and wherein a curved inner surface formed by the primary coil substantially conforms to the outer surface of the heat exchanger body.

3. The electrical transformer core assembly of claim 1, wherein the substantially non-linear outer surface of the heat exchanger body includes a substantially continuous curve without discontinuities.

4. The electrical transformer core assembly of claim 1, wherein the outer surface of the heat exchanger body includes a continuously curved surface opposite a planar inner surface of the heat exchanger body.

5. The electrical transformer core assembly of claim 1, wherein the heat exchanger body is substantially C-shaped, and wherein the inner surface of the heat exchanger body includes a pair of substantially planar side surfaces joined by a substantially planer base surface.

6. The electrical transformer core assembly of claim 1, wherein the inner surface of the heat exchanger body substantially conforms to at least three outer surfaces of the magnetic core.

7. The electrical transformer core assembly of claim 6, wherein the heat exchanger body includes a pair of sides that conform to opposing outer surfaces of the magnetic core.

8. The electrical transformer core assembly of claim 7, wherein the pair of sides of the heat exchanger body include substantially curved outer surfaces.

9. The electrical transformer core assembly of claim 1, further comprising at least one cooling tube within a groove of at least one inner surface of the heat exchanger body.

10. The electrical transformer core assembly of claim 1, wherein the set of coils and heat exchanger are a first set of coils and a first heat exchanger on a first leg of the magnetic core, and the and electrical transformer core assembly further includes a second set of coils and a second heat exchanger located on a second leg of the magnetic core, wherein second set of coils and a second heat exchanger are substantially identical to the first set of coils and first heat exchanger.

11. The electrical transformer core assembly of claim 1, wherein the heat exchanger body extends over a leg of the magnetic core, and wherein the heat exchanger further includes an extension extending from the heat exchanger body over a yoke of the magnetic core.

12. An electrical transformer, comprising:
a magnetic core; and
a heat exchanger located on the magnetic core, the heat exchanger including a heat exchanger body and at least one cooling tube, the heat exchanger body including an outer surface and an inner surface, wherein the outer surface is substantially curved as viewed in a cross-sectional plane, and the inner surface substantially conforms to an outer surface of the magnetic core.

13. The electrical transformer of claim 12, wherein the outer surface of the heat exchanger body includes a continuously curved surface opposite a planar inner surface of the heat exchanger body.

14. The electrical transformer of claim 12, wherein the heat exchanger body is substantially C-shaped, and wherein the inner surface of the heat exchanger body includes three substantially planar surfaces.

15. The electrical transformer of claim 12, wherein the inner surface of the heat exchanger body has a groove for receiving the cooling tube so that the cooling tube is substantially flush with the inner surface of the heat exchanger body.

16. The electrical transformer of claim 15, wherein the heat exchanger body includes a pair of sides having inner surfaces conforming to two outer surfaces of the magnetic core.

17. The electrical transformer of claim 15, wherein the heat exchanger body extends over a leg of the magnetic core, and wherein the heat exchanger further includes an extension extending from the heat exchanger body over a yoke of the magnetic core.

18. A method of forming an electrical transformer, comprising:
securing a heat exchanger about a magnetic core, the heat exchanger including a heat exchanger body including an outer surface opposite an inner surface, wherein the outer surface is substantially continuously curved as viewed in a cross-sectional plane of the heat exchanger body, and the inner surface substantially conforms to an outer surface of the magnetic core;
forming a primary coil by wrapping first foil about the heat exchanger;
securing spacers about the primary coil; and
forming a secondary coil by wrapping a second foil about the spacers.

19. The method of claim 18, wherein:
the inner surface of the heat exchanger body substantially conforms to at least three outer surfaces of the magnetic core, and
two outer surfaces of the magnetic core are normal to a third other outer surface of the at least three outer surfaces.

20. The method of claim 18, further comprising:
forming a groove in at least one inner wall of the heat exchanger body; and
securing a cooling tube within the at least one inner wall of the heat exchanger body by adhering the cooling tube within the groove.
